(19) United States
(12) Patent Application Publication
(10) Pub. No.: US 2014/0068058 A1
(43) Pub. Date: Mar. 6, 2014

(54) USAGE-BASED SORTING OF LOCAL NETWORK SERVICES

(71) Applicant: APPLE INC., Cupertino, CA (US)

(72) Inventor: Andreas Wolf, San Mateo, CA (US)

(73) Assignee: APPLE INC., Cupertino, CA (US)

(21) Appl. No.: 13/627,837

(22) Filed: Sep. 26, 2012

Related U.S. Application Data
(60) Provisional application No. 61/697,457, filed on Sep. 6, 2012.

(51) Int. Cl. G06F 15/173

(52) U.S. Cl. 709/224

(57) ABSTRACT

The disclosed embodiments provide a system that facilitates use of local network services from an electronic device. During operation, the system obtains a usage pattern associated with use of the local network services by a user of the electronic device. Next, upon detecting a subsequent request from the user for a list of the local network services in proximity to the electronic device, the system organizes the list based on the usage pattern.

### RELATED APPLICATION

This application hereby claims priority under 35 U.S.C. §119 to U.S. Provisional Application No. 61/697,457, entitled “Usage-Based Sorting of Local Network Services,” by Andreas Wolf, filed 6 Sep. 2012 (Atty. Docket No.: APL-P13330USP1).

### BACKGROUND

1. Field

The disclosed embodiments relate to techniques for facilitating use of local network services by electronic devices. More specifically, the disclosed embodiments relate to techniques for sorting lists of local network services in proximity to the electronic devices based on usage patterns associated with use of the local network services by users of the electronic devices.

2. Related Art

Recent improvements in computing power and wireless networking technology have significantly increased the capabilities of electronic devices. For example, laptop computers, tablet computers, portable media players, smartphones, digital media receivers, video game consoles, and/or other modern computing devices are typically equipped with WiFi capabilities that allow the computing devices to retrieve webpages, stream audio and/or video, share desktops and/or user interfaces (UIs), and/or transfer files wirelessly among one another.

Such expansion of computing and networking capabilities has resulted in an increase in the computing and/or networking options available to users of the electronic devices. In turn, the abundance of options may create difficulty and/or confusion for the users in locating and/or selecting the most appropriate and/or relevant options from the lists. For example, a user of a laptop computer wishing to connect to a WiFi network may be shown a long list of WiFi networks within range of the laptop computer. If the user is unfamiliar with the WiFi networks, the user may connect to an unsecured WiFi network that subsequently redirects the user to a webpage that requests a login and/or payment from the user before the user is granted Internet access through the WiFi network. The user may thus be required to select multiple WiFi networks from the list before the user finds a suitable WiFi network through which the user may access the Internet without providing a password and/or passphrase and/or paying for Internet access through the WiFi network.

Hence, use of computing and/or networking capabilities of electronic devices may be facilitated by mechanisms for organizing, filtering, and/or recommending options related to the computing and/or networking capabilities to users of the electronic devices.

### SUMMARY

The disclosed embodiments provide a system that facilitates use of local network services from an electronic device. During operation, the system obtains a usage pattern associated with use of the local network services by a user of the electronic device. Next, upon detecting a subsequent request from the user for a list of the local network services in proximity to the electronic device, the system organizes the list based on the usage pattern.

In some embodiments, the system also updates the usage pattern with a selection of a local network service from the list by the user.

In some embodiments, updating the usage pattern with the selection involves identifying a type of the local network service based on a set of attributes associated with the local network service, and updating the usage pattern with the type.

In some embodiments, the usage pattern is updated using at least one of an artificial neural network, a classifier, and an evolutionary-computation technique.

In some embodiments, organizing the list based on the usage pattern involves identifying a subset of the local network services matching the usage pattern, and prioritizing display of the subset within the list.

In some embodiments, prioritizing display of the subset within the list involves at least one of:

(i) placing the subset at the top of the list;

(ii) displaying the subset in bold;

(iii) displaying the subset with a blinking effect; and

(iv) hiding other local network services not in the subset from the user.

In some embodiments, the local network services are associated with at least one of a wireless network, an ad hoc network, and a discovery protocol. For example, the local network services may include peer-to-peer file transfer services, printer services, ad hoc wireless networks, and/or WiFi networks.

### BRIEF DESCRIPTION OF THE FIGURES

FIG. 1 shows an exemplary interaction between an electronic device and a set of electronic devices providing local network services in accordance with the disclosed embodiments.

FIG. 2 shows a system for facilitating use of local network services from an electronic device in accordance with the disclosed embodiments.

FIG. 3 shows an exemplary screenshot in accordance with the disclosed embodiments.

FIG. 4 shows a flowchart illustrating the process of facilitating use of local network services from an electronic device in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

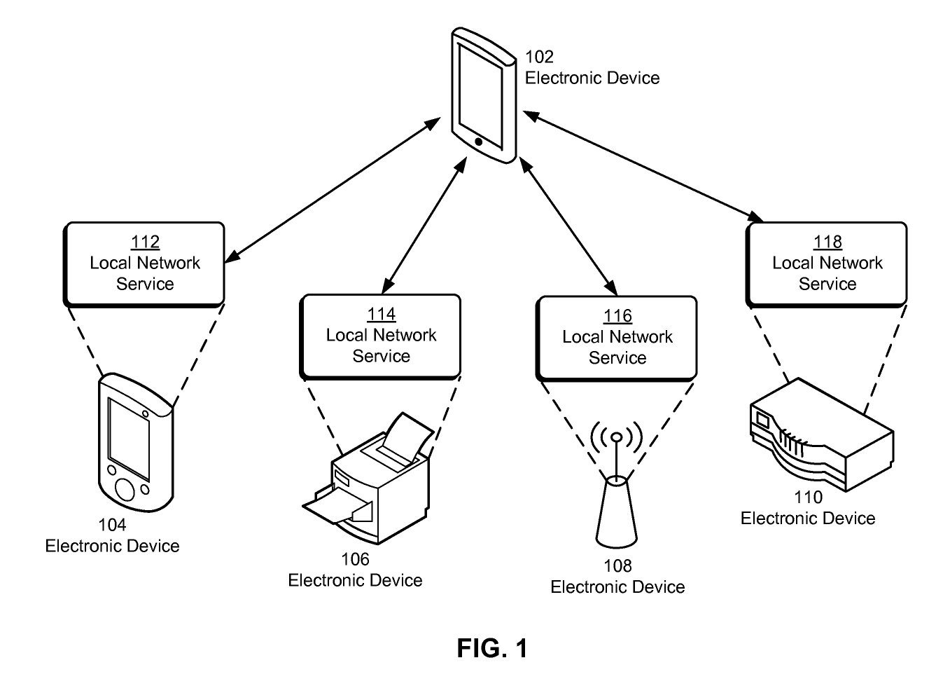

The disclosed embodiments provide a method and system for facilitating use of local network services from an electronic device such as a mobile phone, personal computer, laptop computer, tablet computer, portable media player, and/or other network-enabled electronic device. As shown in FIG. 1, an electronic device 102 may detect a number of local network services 112-118 from other electronic devices 104-110 in proximity to electronic device 102.

Local network services 112-118 may be computing and/or networking services that are available to electronic device 102 if electronic devices 104-110 are in proximity to electronic device 102. For example, local network services 112-114 may include a peer-to-peer file transfer service advertised by electronic device 104 and a printing service advertised by electronic device 106 through a discovery protocol such as Bonjour (Bonjour™ is a registered trademark of Apple Inc.). Similarly, local network services 116-118 may be wireless networks (e.g., WiFi networks (WiFi™ is a registered trademark of the Wi-Fi Alliance), Bluetooth (Bluetooth™ is a registered trademark of Bluetooth SIG, Inc.) networks, cellular networks, etc.) provided by electronic devices 108-110 such as wireless access points and/or wireless routers.

To use a local network service (e.g., local network services 112-118), a user of electronic device 102 may select the local network service from a list of local network services displayed within a user interface of electronic device 102. For example, the user may connect electronic device 102 to a WiFi network by viewing a list of all WiFi networks detected by electronic device 102, locating the WiFi network within the list, and selecting the WiFi network. Similarly, the user may perform a print job by viewing a list of all printers advertising printing services on the same local area network (LAN) as electronic device 102 and selecting a printer from the list.

Those skilled in the art will appreciate that increases in the number and capabilities of electronic devices (e.g., electronic devices 104-110) in proximity to electronic device 102 may cause lists of local network services (e.g., local network services 112-118) shown on electronic device 102 to expand. For example, the user may be shown a large number of WiFi networks in range of electronic device 102 if electronic device 102 is located in a city. At the same time, the increasing number of local network services available to the user may create difficulty and/or confusion for the user in selecting the most appropriate and/or best local network service for use from electronic device 102. For example, the presence of multiple printers on the same LAN as electronic device 102 may cause the user to select a printer that is far away from and/or inaccessible to the user for a print job on electronic device 102.

In one or more embodiments, selection of local network services from electronic device 102 is facilitated by organizing and/or sorting lists of the local network services based on prior usage of the local network services by the user. In particular, a usage pattern associated with use of the local network services by the user may be tracked. The usage pattern may then be used to organize a list of the local network services in proximity to electronic device 102 so that a subset of local network services that match the usage pattern are prioritized within the list. As discussed in further detail below, such prioritization may facilitate the selection and/or use of appropriate and/or relevant local network services from the list.

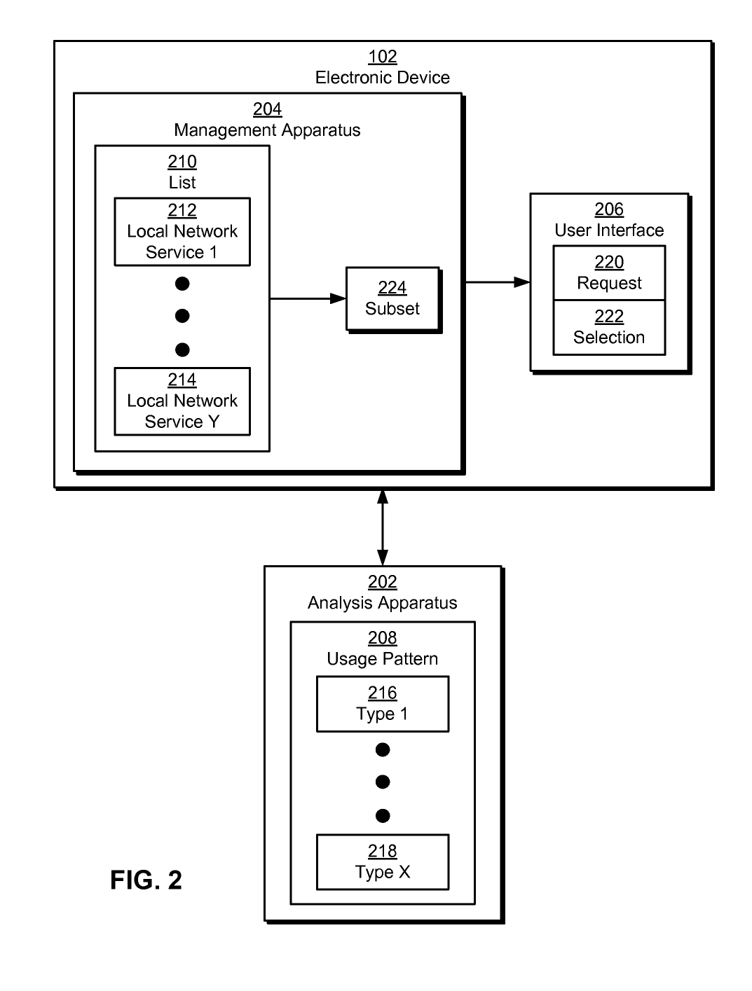

FIG. 2 shows a system for facilitating use of local network services (e.g., local network services 112-118 of FIG. 1) from electronic device 102 in accordance with the disclosed embodiments. As shown in FIG. 2, the system includes an analysis apparatus 202 and a management apparatus 204. Each of these components is described in further detail below.

Analysis apparatus 202 may track a usage pattern 208 associated with use of the local network services by a user of electronic device 102. Usage pattern 208 may contain a record of previous use of the local network services. For example, usage pattern 208 may characterize the user's usage of WiFi networks, ad hoc wireless networks, printer services, and/or services advertised through a discovery protocol on electronic device 102 and/or other electronic devices.

In one or more embodiments, analysis apparatus 202 uses a learning technique to create and/or update usage pattern 208. For example, analysis apparatus 202 may track attributes common to local network services used by the user using an artificial neural network, a classifier, and/or an evolutionary-computation technique. As a result, usage pattern 208 may contain a set of types (e.g., type 1 216, type x 218) associated with the previously used local network services. For example, each type may encode a set of attributes associated with a WiFi network previously used by the user, including a security type (e.g., Wired Equivalent Privacy (WEP), WiFi Protected Access (WPA), WPA2, etc.), signal strength, name, time of use, frequency of use, length of use, network type (e.g., 802.11b, 802.11g, 802.11n), frequency band (e.g., 2.4 GHz, 5 GHz), mode (e.g., ad hoc, infrastructure, etc.), and/or Media Access Control (MAC) address.

As mentioned above, usage pattern 208 may be used to organize and/or sort a list 210 of local network services (e.g., local network service 1 212, local network service y 214) in proximity to electronic device 102. List 210 may be shown to the user after a request 220 for list 210 is received from the user through a user interface 206 of electronic device 102. For example, the user may submit request 220 to user interface 206 if the user wishes to view and/or use one or more local network services from electronic device 102.

More specifically, management apparatus 204 may detect request 220 and organize list 210 based on usage pattern 208 before list 210 is shown to the user. As shown in FIG. 2, management apparatus 204 may identify a subset 224 of the local network services matching usage pattern 208 and prioritize display of subset 224 within list 210 and/or user interface 206. For example, management apparatus 204 may obtain attributes such as high signal strength and/or lack of encryption from the user's usage pattern 208 of WiFi networks and select subset 224 as the set of local network services in list 210 that have high signal strength and/or are unsecured. Management apparatus 204 may then display list 210 through user interface 206 so that subset 224 is placed at the top of list 210, shown in bold, and/or shown with a blinking effect. Management apparatus 204 may also hide other local network services not in subset 224 from the user unless the user selects an option (e.g., “show all”) to show the other local network services in list 210 within user interface 206.

Management apparatus 204 and/or user interface 206 may additionally obtain a selection 222 of a local network service from list 210 by the user, and analysis apparatus 202 may update usage pattern 208 with selection 222. For example, the user may provide selection 222 to initiate use of the selected local network service from electronic device 102. After selection 222 is received by management apparatus 204 and/or user interface 206, analysis apparatus 202 may classify the selected local network service as one of several types based on a set of attributes associated with the local network service. Analysis apparatus 202 may then add the type to usage pattern 208 to enable use of the type in subsequent organization of list 210 and/or other lists of local network services shown to the user.

Such organization of local network services within list 210 may allow the user to quickly locate and/or select the most relevant and/or appropriate local network service for use with electronic device 102 instead of attempting to find a suitable local network service by reviewing the entire list 210 and/or through trial and error. In addition, continued tracking of the user's behavior and/or preferences with usage pattern 208 (e.g., through the addition of types associated with recent selections of local network services to usage pattern 208) may allow the organization of list 210 to reflect changes to the user's behavior and/or preferences. For example, analysis apparatus 202 may observe a significant effect of the location of electronic device 102 on the user's selection of local network services and add location attributes to types in usage pattern 208. The location attributes may then be used by management apparatus 204 in selecting a subset 224 of the local network services that is relevant to the location of electronic device 102.

Those skilled in the art will appreciate that the system of FIG. 2 may be implemented in a variety of ways. In particular, analysis apparatus 202 may reside on electronic device 102 or execute independently from electronic device 102. For example, analysis apparatus 202 may execute on electronic device 102 and track usage pattern 208 based on the local network services selected and used by the user from electronic device 102. Alternatively, analysis apparatus 202 may be provided by a server that monitors usage pattern 208 across multiple electronic devices used by the user (e.g., through a user account of the user) and provides updates to usage pattern 208 to the electronic devices. Analysis apparatus 202 may thus allow the user to have the same experience across the electronic devices, including new electronic devices with little to no previous usage of local network services by the user.

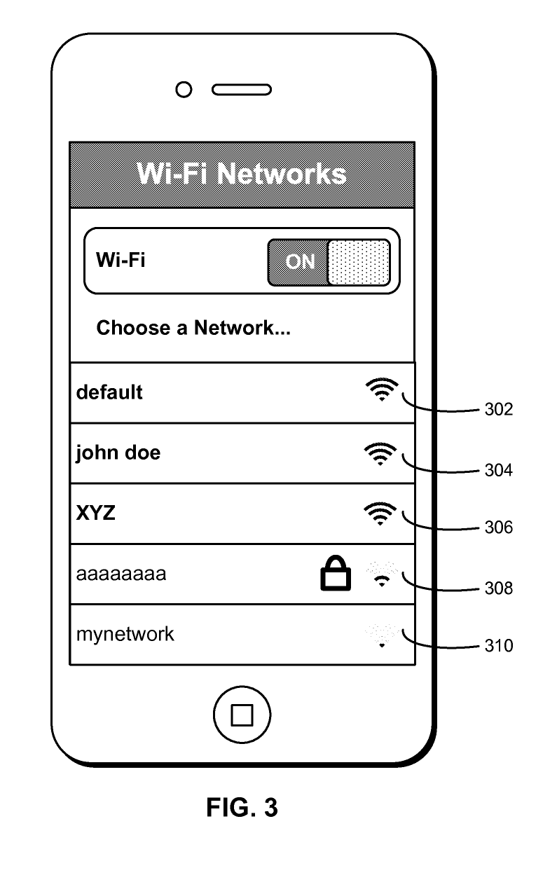

FIG. 3 shows an exemplary screenshot in accordance with the disclosed embodiments. More specifically, FIG. 3 shows a screenshot of a user interface in an electronic device, such as user interface 206 of FIG. 2. Within the user interface, a list of local network services 302-310 is shown. For example, the user interface may show a list of WiFi networks to a user of the electronic device, and the user may connect the electronic device to one of the WiFi networks by selecting a local network service 302-310 representing the WiFi network from the list.

In addition, local network services 302-310 may be organized according to a usage pattern associated with use of local network services 302-310 by the user. As shown in FIG. 3, local network services 302-306 are shown at the top of the list in bold, while local network services 308-310 are shown after local network services 302-306 in regular font. Local network services 302-306 may thus correspond to a subset of local network services 302-310 that match the usage pattern. For example, local network services 302-306 may match a usage pattern of selecting unsecured WiFi networks with high signal strength. On the other hand, local network services 308-310 may not match the usage pattern because local network services 308-310 represent WiFi networks with low signal strength and/or encryption.

Such prioritization of local network services 302-306 over local network services 308-310 in the list may allow the user to more easily and/or efficiently select a suitable local network service 302-310 for use by the electronic device than if local network services 302-310 were displayed alphabetically and/or according to a non-usage-based order. For example, the list may encourage the user to immediately select one of the first three local network services 302-306 instead of requiring the user to scroll through a long list of local network services to find an unsecured WiFi network with high signal strength.

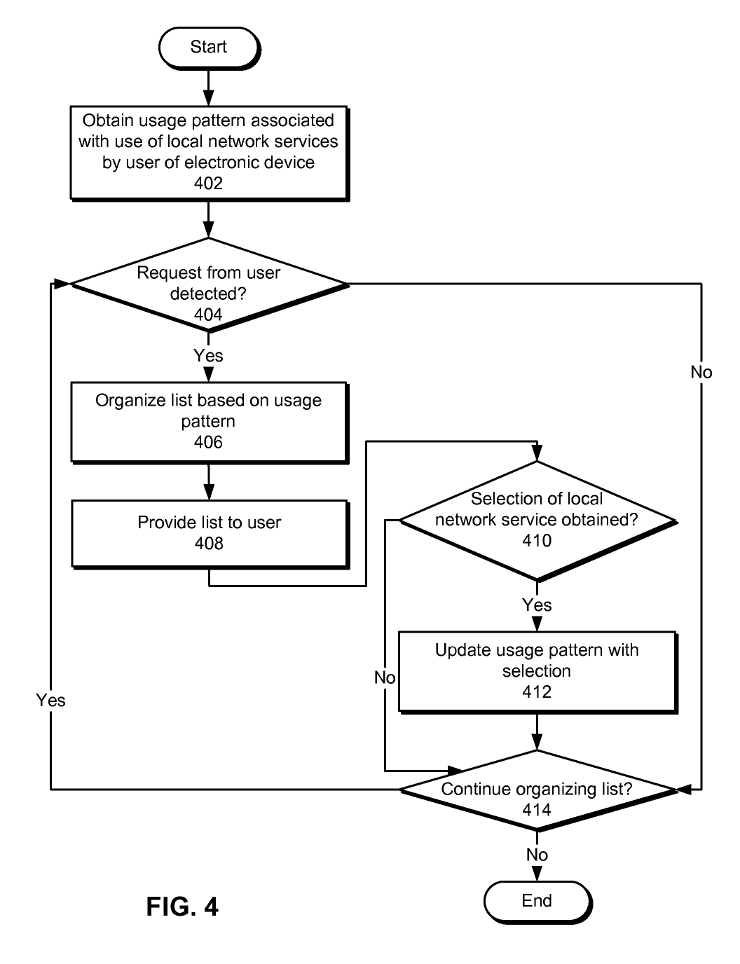

FIG. 4 shows a flowchart illustrating the process of facilitating use of local network services from an electronic device in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, a usage pattern associated with use of the local network services by a user of the electronic device is obtained (operation 402). The local network services may be associated with a wireless network, an ad hoc network, and/or a discovery protocol. For example, the local network services may include WiFi and/or Bluetooth networks within range of the electronic device, other electronic devices with which the electronic device may form wireless ad hoc networks and/or perform peer-to-peer file transfer, and/or services advertised by electronic devices using the discovery protocol. The usage pattern may contain information related to the user's previous usage of the local network services. For example, the usage pattern may contain a record of attributes associated with previous use of the local network services by the user.

A request from the user for a list of local network services in proximity to the electronic device may be detected (operation 404). For example, the request may be received if the user wishes to use one or more of the local network services in proximity to the electronic device. If the request is not detected, the list is not organized or shown to the user.

If the request is detected, the list is organized based on the usage pattern (operation 406) and provided to the user (operation 408). For example, a subset of the local network services matching the usage pattern may be identified. Display of the subset within the list may then be prioritized by placing the subset at the top of the list, displaying the subset in bold, displaying the subset with a blinking effect, and/or hiding other local network services not in the subset from the user. Alternatively, the list may be organized (e.g., using a background process) before requests for the list are made by the user so that the list may be ready for display to the user once a request is received and/or detected.

A selection of a local network service from the list by the user may also be obtained (operation 410). For example, the user may select the local network service to use the local network service from the electronic device. If a selection is obtained from the user, the usage pattern is updated with the selection (operation 412). For example, an artificial neural network, a classifier, and/or an evolutionary-computation technique may be used to identify a type of the local network service based on a set of attributes associated with the local network service. The usage pattern may then be updated with the type, either at the electronic device or with a user account for the user. If no selection is obtained from the user, the usage pattern is not updated.

Organizing of the list may continue (operation 414) during use of local network services by the user from the electronic device. If organization of the list is to continue, the list is organized based on the usage pattern and provided to the user in response to the user's requests for the list (operations 404-408), and the usage pattern is updated with the user's selections of local network services from the list (operations 410-412). Such organization of the list and updating of the usage pattern may continue until the electronic device and/or local network services are no longer used by the user and/or organizing of the list is otherwise disabled on the electronic device.

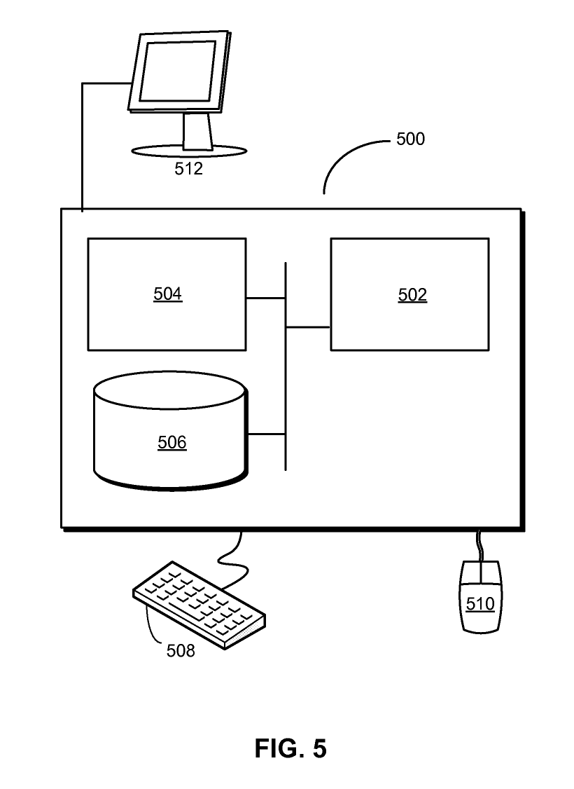

FIG. 5 shows a computer system 500 in accordance with the disclosed embodiments. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating use of local network services from an electronic device. The system may include an analysis apparatus that tracks a usage pattern associated with use of the local network services by a user of the electronic device. The system may also include a management apparatus that organizes a list of local network services in proximity to the electronic device based on the usage pattern upon detecting a subsequent request from the user for the list. The management apparatus may also obtain a selection of a local network service from the list by the user, and the analysis apparatus may update the usage pattern with the selection.

In addition, one or more components of computer system 500 may be remotely located and connected to the other components over a network. Portions of the present embodiments (e.g., analysis apparatus, management apparatus, etc.) may also be located on different nodes of a distributed system that implements the embodiments. For example, the present embodiments may be implemented using a cloud-computing system that sorts and/or organizes lists of local network services for users of a set of remote electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating use of local network services from an electronic device, comprising:
obtaining, at the electronic device, a usage pattern associated with use of the local network services by a user of the electronic device; and
upon detecting a subsequent request from the user for a list of the local network services in proximity to the electronic device, organizing the list based on the usage pattern.

2. The computer-implemented method of claim 1, further comprising:
updating the usage pattern with a selection of a local network service from the list by the user.

3. The computer-implemented method of claim 2, wherein updating the usage pattern with the selection involves:
identifying a type of the local network service based on a set of attributes associated with the local network service; and
updating the usage pattern with the type.

4. The computer-implemented method of claim 2, wherein the usage pattern is updated using at least one of an artificial neural network, a classifier, and an evolutionary-computation technique.

5. The computer-implemented method of claim 1, wherein organizing the list based on the usage pattern involves:
identifying a subset of the local network services matching the usage pattern; and
prioritizing display of the subset within the list.

6. The computer-implemented method of claim 5, wherein prioritizing display of the subset within the list involves at least one of:
placing the subset at the top of the list;
displaying the subset in bold;
displaying the subset with a blinking effect; and
hiding other local network services not in the subset from the user.

7. The computer-implemented method of claim 1, wherein the local network services are associated with at least one of:
a wireless network;
an ad hoc network; and
a discovery protocol.

8. A system for facilitating use of local network services from an electronic device, comprising:
an analysis apparatus configured to track a usage pattern associated with use of the local network services by a user of the electronic device; and
a management apparatus configured to organize a list of local network services in proximity to the electronic device based on the usage pattern upon detecting a subsequent request from the user for the list.

9. The system of claim 8,
wherein the management apparatus is further configured to obtain a selection of a local network service from the list by the user, and
wherein the analysis apparatus is further configured to update the usage pattern with the selection.

10. The system of claim 9, wherein updating the usage pattern with the selection involves:
identifying a type of the local network service based on a set of attributes associated with the local network service; and
updating the usage pattern with the type.

11. The system of claim 9, wherein the usage pattern is updated using at least one of an artificial neural network, a classifier, and an evolutionary-computation technique.

12. The system of claim 8, wherein the usage pattern is tracked using at least one of:
the electronic device; and
a user account for the user.

13. The system of claim 8, wherein organizing the list based on the usage pattern involves:
identifying a subset of the local network services matching the usage pattern; and
prioritizing display of the subset within the list.

14. The system of claim 13, wherein prioritizing display of the subset within the list involves at least one of:
placing the subset at the top of the list;
displaying the subset in bold;
displaying the subset with a blinking effect; and
hiding other local network services not in the subset from the user.

15. The system of claim 8, wherein the local network services are associated with at least one of:
a wireless network;
an ad hoc network; and
a discovery protocol.

16. A computer-readable storage medium storing instructions that when executed by a computer cause the computer to perform a method for facilitating use of local network services from an electronic device, the method comprising:
obtaining, at the electronic device, a usage pattern associated with use of the local network services by a user of the electronic device; and
upon detecting a subsequent request from the user for a list of the local network services in proximity to the electronic device, organizing the list based on the usage pattern.

17. The computer-readable storage medium of claim 16, the method further comprising:
updating the usage pattern with a selection of a local network service from the list by the user.

18. The computer-readable storage medium of claim 17, wherein updating the usage pattern using the learning technique involves:
identifying a type of the local network service based on a set of attributes associated with the local network service; and
updating the usage pattern with the type.

19. The computer-readable storage medium of claim 17, wherein the usage pattern is updated using at least one of an artificial neural network, a classifier, and an evolutionary-computation technique.

20. The computer-readable storage medium of claim 16, wherein organizing the list based on the usage pattern involves:
identifying a subset of the local network services matching the usage pattern; and
prioritizing display of the subset within the list.

21. The computer-readable storage medium of claim 20, wherein prioritizing display of the subset within the list involves at least one of:
placing the subset at the top of the list;
displaying the subset in bold;
displaying the subset with a blinking effect; and
hiding other local network services not in the subset from the user.

22. The computer-readable storage medium of claim 16, wherein the local network services are associated with at least one of:
a wireless network;
an ad hoc network; and
a discovery protocol.
